(19) United States
(12) Patent Application Publication
(10) Pub. No.: US 2004/0165389 A1
(43) Pub. Date: Aug. 26, 2004

(54) Modified structure of projector

(76) Inventors: Jih-Ching Chang, Hsinchu (TW); Teng-Chou Yang, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/372,137

(22) Filed: Feb. 25, 2003

(51) Int. Cl. F21V 1/00

(52) U.S. Cl. 362/317

(57) ABSTRACT

A modified structure of a projector comprises a projector body, a first activating device, a camera lens set and a remote control host machine. The first activating device is installed on the projector body. The camera lens set is installed on the first activating device, and can move thereon to increase or decrease the magnification ratio of image. The camera lens set has a second activating device, which is used to adjust the position of a camera lens for fine tuning of focus. The remote control host machine can be maneuvered for automatic adjustment and setting of the projector. Because the first activating device can move the camera lens set upwards or downwards to automatically zoom an image, and the second activating device can automatically focus the camera lens, the trouble of manual operation of the user can be saved.

### FIELD OF THE INVENTION

The present invention relates to a projector and, more particularly, to a modified structure of an object projector capable of automatically zooming and focusing images.

### BACKGROUND OF THE INVENTION

An object projector can directly projects various kinds of objects and data like books, charts, models, samples, figures and scenes without the need of making projection sheets, hence saving the time and cost of making projection sheets and also accomplishing easy operations.

For a conventional object projector, its camera lens set is manually moved to change the magnification ratio of image and to adjust the focus of lens. As shown in FIG. 1A, for a conventional pull type projector 10, a pull type support rack 14 is first screwed out from a base 12. The pull type support rack 14 is then adjusted to zoom the image. Next, as shown in FIG. 1B, the direction of a camera lens set 16 is adjusted to turn the camera lens set 16 to an object placement region so that a camera lens 17 faces the object placement region. Finally, a focus length adjustment device 18 is manually turned to focus the camera lens 17. As shown in FIG. 2A, for another conventional turn type projector 20, a turn type support rack 24 is first screwed out from a base 22. The turn type support rack 24 is then adjusted by turning to zoom the image. Next, as shown in FIG. 2B, the direction of a camera lens set 26 is adjusted to turn the camera lens set 26 to an object placement region so that a camera lens 27 faces the object placement region. Finally, a focus length adjustment device 28 is manually turned to focus the camera lens 27. Regardless of the pull type projector 10 or the turn type projector 20, when a user wants to zoom an image during the process of teaching, he needs to go to the object projector to adjust the required magnification ratio by himself, hence resulting in much inconvenience and trouble.

Accordingly, the present invention aims to propose a modified structure of a projector to resolve the problems in the prior art.

### SUMMARY AND OBJECTS OF THE PRESENT INVENTION

The primary object of the present invention is to propose a modified structure of a projector, wherein an activating device is utilized to move a camera lens set upwards or downwards to automatically zoom an image, and another activating device is utilized to move the position of a camera lens to accomplish the function of automatic focusing, thereby saving the time for positioning and ensuring the quality of image.

Another object of the present invention is to propose a modified structure of a projector, whereby a remote control host machine can be maneuvered to move a camera lens set upwards or downwards for automatically zooming an image and to automatically focus a camera lens. Therefore, the height and angle of the camera lens can be arbitrarily adjusted to accomplish the best angle for presenting a briefing frame, hence saving the trouble of manual operation of the user.

Another object of the present invention is to propose a modified structure of a projector having the effects of practicality, convenient use and simple operation.

To achieve the above objects, the present invention comprises a projector body, a first activating device, a camera lens set and a remote control host machine. The projector body has a remote control receiver built therein. The first activating device is installed on the projector body, and can rotate thereon. The camera lens set is installed on the first activating device, and can move thereon to increase or decrease the magnification ratio of image. The camera lens set has a second activating device, which is used to adjust the position of a camera lens for fine tuning of focus. The remote control host machine can be maneuvered to let the remote control receiver receive signals emitted therefrom. The remote control host machine can thus control the projector for automatic adjustment and setting.

The various objects and advantages of the present invention will be more readily understood from the following detailed description when read in conjunction with the appended drawings, in which:

### BRIEF DESCRIPTION OF DRAWING

FIG. 1A is a structure diagram of a conventional pull type projector;

FIG. 1B is another structure diagram of a conventional pull type projector;

FIG. 2A is a structure diagram of a conventional turn type projector;

FIG. 2B is another structure diagram of a conventional turn type projector;

FIG. 3 is a structure diagram of the present invention;

FIG. 4 is a side view of the present invention;

FIGS. 5A to 5D are action diagrams of the present invention;

FIGS. 6A and 6B are structure diagrams before and after the action of a camera lens according to another embodiment of the present invention, respectively; and

FIGS. 7A and 7B are structure diagrams before and after the action of a camera lens according to yet another embodiment of the present invention, respectively.

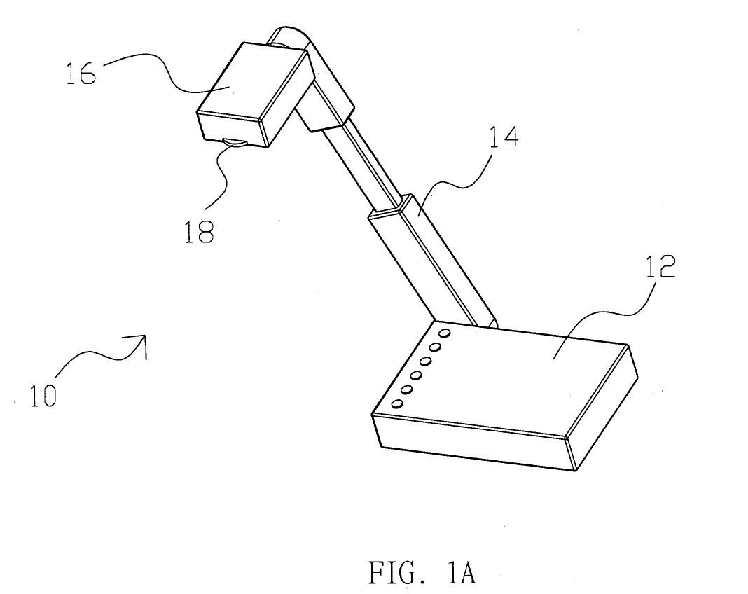

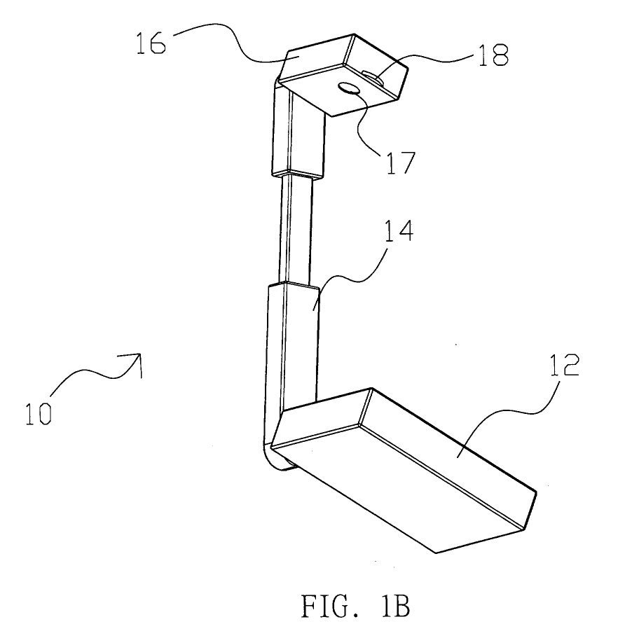

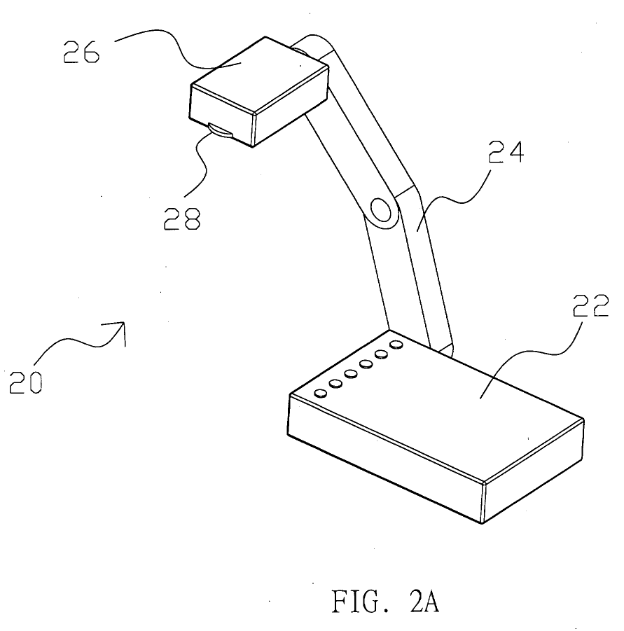

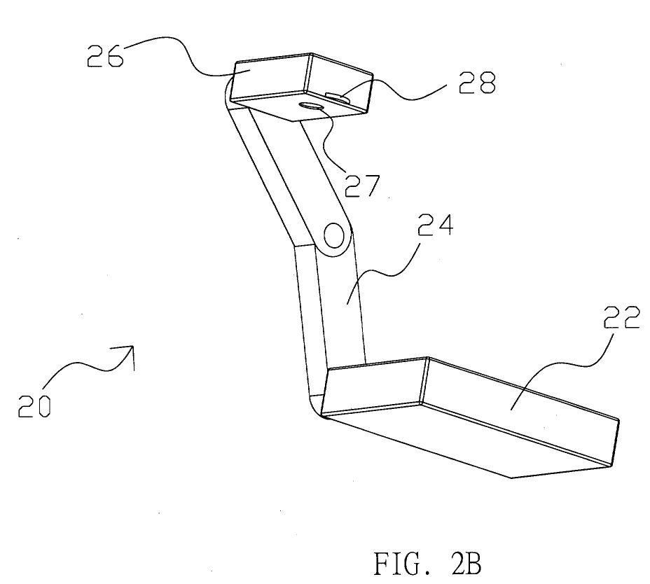

### DETAILED DESCRIPTION OF PREFERRED EMBODIMENT

The present invention makes use of a first activating device to move a camera lens set upwards or downwards for automatic zoom of image, and then makes use of a second activating device to automatically focus a camera lens, thereby saving the time for positioning and the trouble of manual operation of the user.

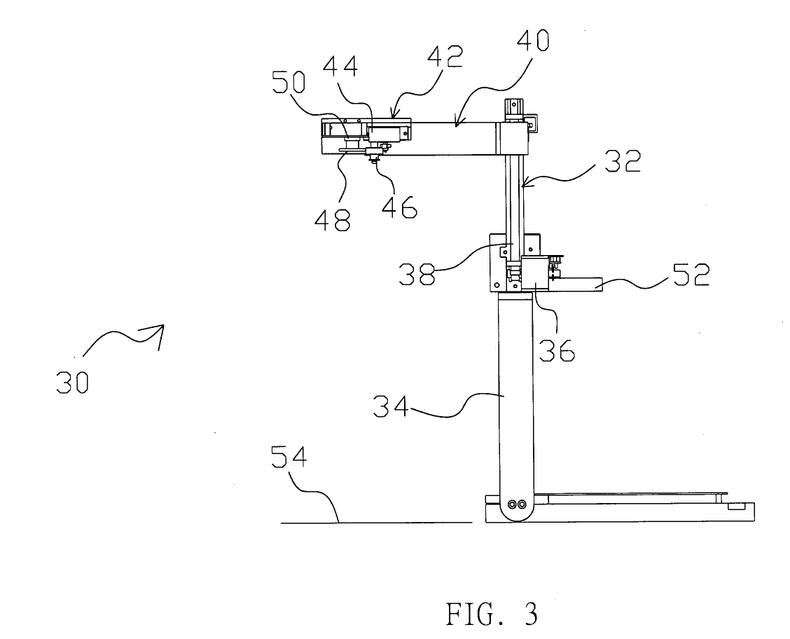

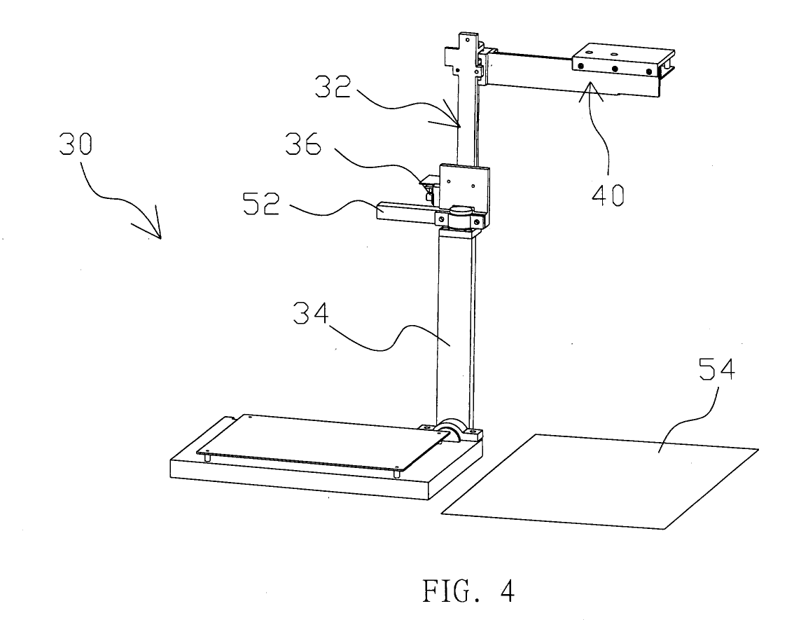

As shown in FIGS. 3 and 4, a modified structure of a projector comprises a projector body 30 with a remote control receiver (not shown) built therein. An object placement region 54 is disposed beside the projector body 30. A support arm 34 is installed on the projector body 30, and can rotate on the projector body 30. A first activating device 32 is installed on the support arm 34, and can rotate on the support arm 34. The first activating body 32 has a first drive component 36, which is a stepper motor. The first drive component 36 drives a first transmission device 38, which is a screw rod set. The first activating device 32 has also a handle 50, which can lead the first activating device 32 to turn. A camera lens set 40 is installed on the first activating device 32, and can move on the first activating device 32. The camera lens set 40 has a second activating device 42. The second activating device 42 has a second drive component 44, which is a stepper motor. The second drive component 44 drives a second transmission device 46, which is a gear set. The second activating device 42 adjusts the position of a camera lens 48 for fine tuning of focus so that a photo detection component 50 can pick an image via the camera lens 48. The photo detection component 50 is a charge coupled device (CCD). A remote control host machine (not shown) can be maneuvered to let the remote control receiver receive a signal emitted therefrom so that the remote control receiver can control the projector for automatic adjustment and setting.

The first drive component 36 and the second drive component 44 can also be a DC motor or a servomotor. The first transmission device 38 can also be a belt set, a chain set, or a gear set. The second transmission device can also be a screw rod set, a belt set, or a chain set. The photo detection component 50 can also be a complementary metal oxide semiconductor (CMOS).

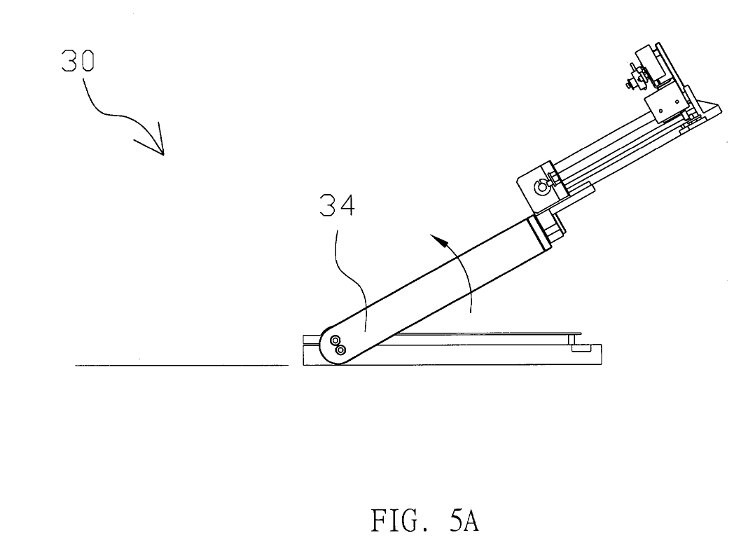

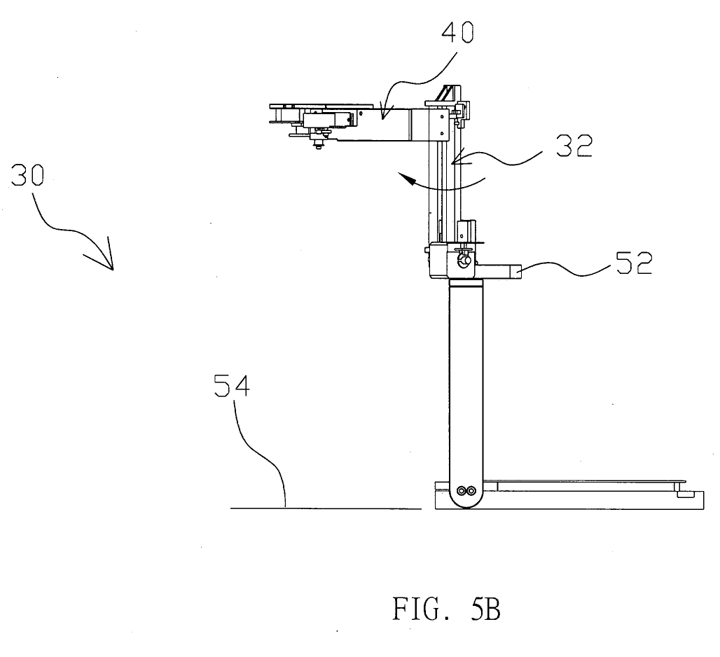

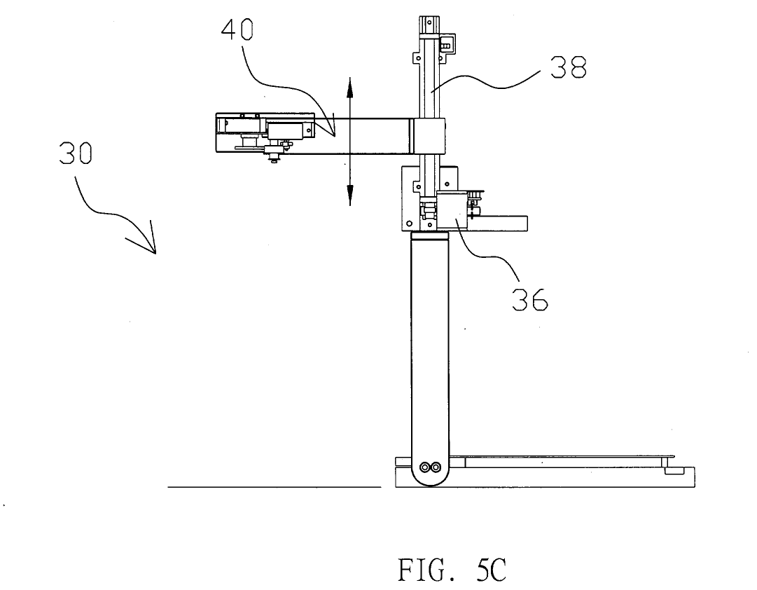

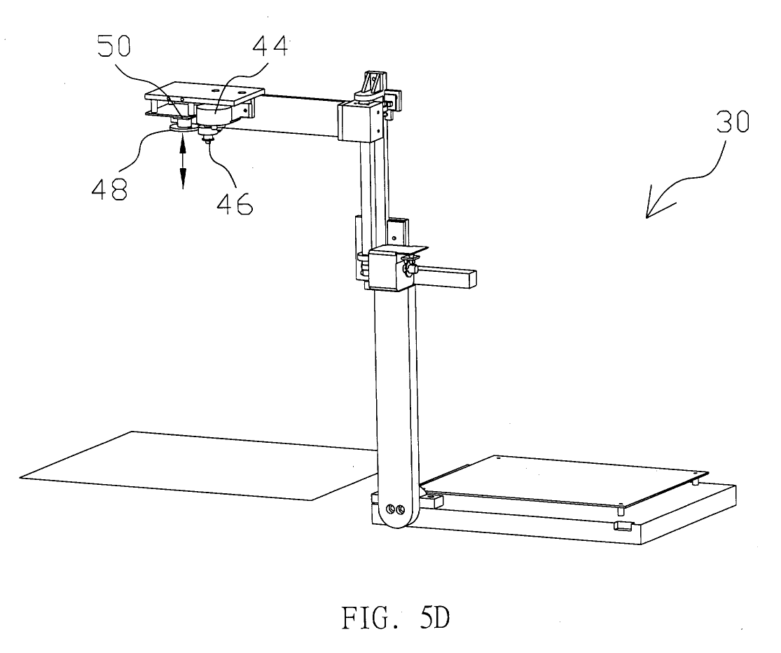

As shown in FIG. 5A, the support arm 34 is first screwed out from the projector body 30 to be vertical. The handle 52 is then used to turn the first activating device 32 to let the camera lens set 40 face the object placement region 54. Next, as shown in FIG. 5C, the remote control host machine can be maneuvered to let the remote control receiver built in the projector body 30 control the first drive component 36. The first drive component 36 can thus drive the first transmission device 38 to move the camera lens set 40 upwards or downwards for gradually enlarging or shrinking texts or charts, hence letting the user be capable of adjusting to the optimum size. Subsequently, as shown in FIG. 5D, the remote control host machine is maneuvered to let the remote control receiver built in the projector body 30 control the second drive component 44. The second drive component 44 can thus drive the second transmission device 46 to move the camera lens 48 upwards or downwards to the optimum position for fine tuning of focus. A control circuit is also matched to automatically control the aperture so that the photo detection component 50 can pick an image via the camera lens 48. Image processing function is then exploited to let an external television or screen display a sharp image.

The camera lens 48 can be an electric zoom camera lens, which is matched with the first activating device 32 for adjustment of the magnification ratio of image to obtain a double effect. Or a special microscope connector can be connected to clearly display any biologic or chemical experiment process under the microscope on the projection screen, hence letting the teaching effect be better.

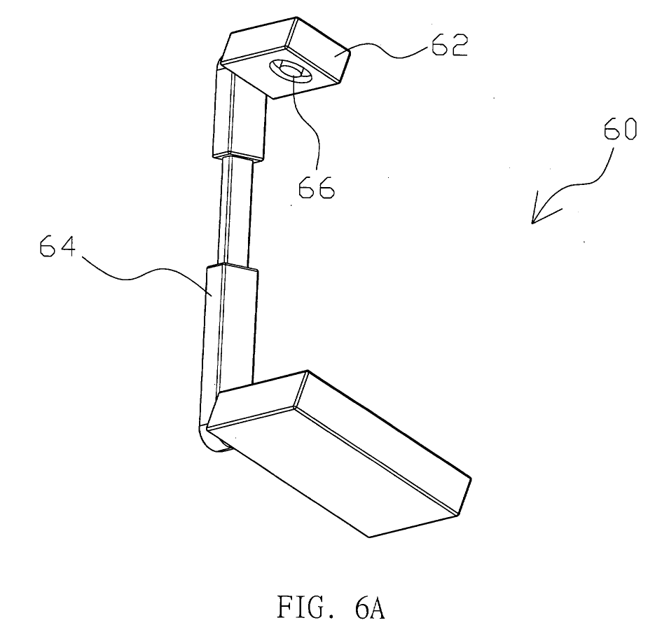

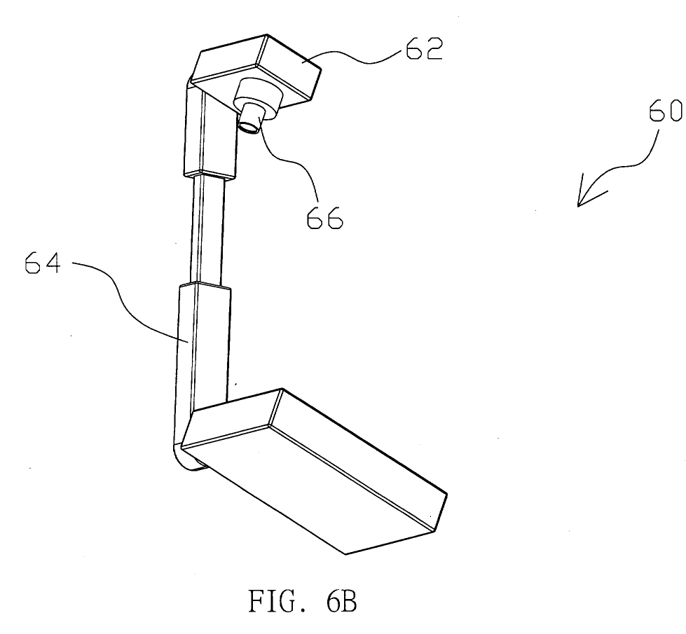

Moreover, as shown in FIG. 6A, a modified structure of a projector comprises a projector 60 with a remote control receiver (not shown) built therein. A pull type support arm 64 is installed on the projector 60, and can rotate on the projector 60. A camera lens set 62 is installed at the top end of the pull type support arm 64. The camera lens set 62 has a drive component (not shown). The drive component drives a transmission device (not shown) to adjust an electric zoom camera lens 66 for magnification or shrinkage of image or fine tuning of focus. A photo detection component (not shown) can thus pick an image via the electric zoom camera lens 66. A remote control host machine (not shown) can be maneuvered to let the remote control receiver receive a signal emitted therefrom so that the remote control receiver can control the projector for automatic adjustment and setting.

In the above embodiment, after the pull type support arm 64 is screwed out from the projector 60, the pull type support arm 64 is adjusted to a predetermined position. Next, the camera lens set 62 is turned to face the object placement region. Finally, the remote control host machine is maneuvered to let the remote control receiver built in the projector 60 control the drive component. The drive component can thus drive the transmission device to adjust the length of the electric zoom camera lens 66 for magnification or shrinkage of image or fine tuning of focus, as shown in FIG. 6B. A photo detection component (not shown) can thus pick an image via the electric zoom camera lens 66. Image processing function is then exploited to let an external television or screen display a sharp image.

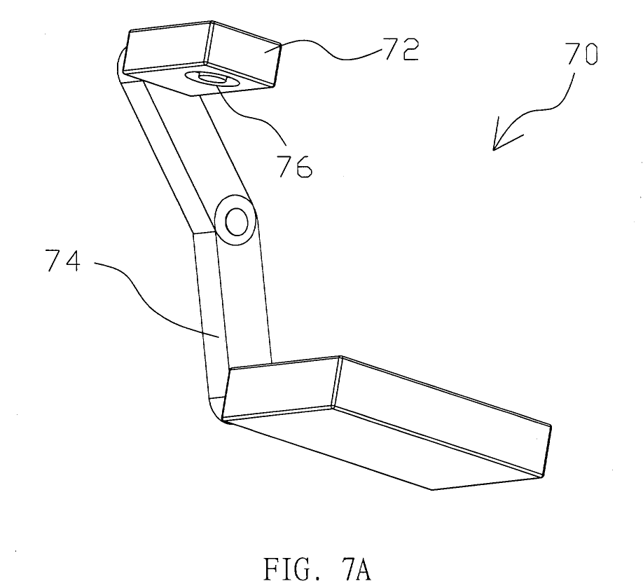

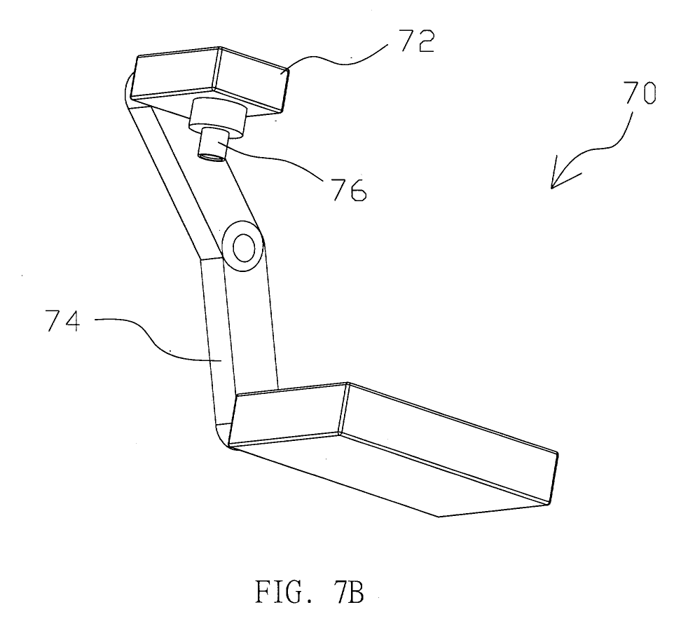

Additionally, the pull type support arm 64 can also be replaced with a turn type support arm 74, as shown in FIG. 7A. The operation steps of a projector 70 are the same as those of the projector 60. After the turn type support arm 74 is screwed out from the projector 70, the turn type support arm 74 is adjusted to a predetermined position. The remote control host machine is then maneuvered to remotely control the electric zoom camera lens 66 for magnification or shrinkage of image or fine tuning of focus, as shown in FIG. 6B, hence accomplishing the same effect as that of the projector 60.

To sum up, the present invention proposes a modified structure of a projector, wherein a first activating device is utilized to move a camera lens set upwards or downwards to automatically zoom an image, and a second activating device is utilized to automatically focus a camera lens. Advanced image processing function is also matched to let an image be clearly displayed on a briefing screen, hence saving the time for positioning and ensuring the quality of image. Moreover, a remote control host machine can be maneuvered to move the camera lens set upwards or downwards for automatically zooming an image and to automatically focus the camera lens. It is not necessary for a user to move the briefing document in a great bustle, and the trouble of manual operation of the user can be omitted. The best angle for clearly presenting teaching materials regardless of textbooks, charts and texts, or temporary hand-written data can be accomplished. The present invention has also the effects of practicality, convenient use and simple operation.

Although the present invention has been described with reference to the preferred embodiments thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim:

1. A modified structure of a projector, comprising:
a projector body with a remote control receiver built therein;
a first activating device installed on said projector body, said first activating device being capable of rotating on said projector body;
at least a camera lens set installed on said first activating device, said camera lens set being capable of moving on said first activating device to increase or decrease the magnification ratio of image, said camera lens set having a second activating device, said second activating device being used to adjust the position of a camera lens for fine tuning of focus so that a photo detection component can pick an image through said camera lens; and
a remote control host machine, said remote control host machine being maneuvered to let said remote control receiver receive a signal emitted from said remote control host machine so that said remote control receiver can control said projector for automatic adjustment and setting.

2. The modified structure of a projector as claimed in claim 1, wherein said remote control host machine can further remotely control said first activating device for automatic adjustment of the magnification ratio and said second activating device for automatic fine tuning of focus.

3. The modified structure of a projector as claimed in claim 1, wherein said first activating device comprises a first drive component, said first drive component drives a first transmission device so that said camera lens set can move on said first activating device.

4. The modified structure of a projector as claimed in claim 3, wherein said first drive component is a stepper motor, a DC motor, or a servomotor.

5. The modified structure of a projector as claimed in claim 3, wherein said first transmission device is a screw rod set, a belt set, a chain set, or a gear set.

6. The modified structure of a projector as claimed in claim 1, wherein a support arm can further be installed between said first activating device and said projector body, said first activating device can rotate on said support arm, and said support arm can rotate on said projector body.

7. The modified structure of a projector as claimed in claim 1 or 6, wherein a handle can further be disposed on said first activating device to drive said first activating device to rotate.

8. The modified structure of a projector as claimed in claim 1, wherein said second activating device comprises a second drive component, said second drive component drives a second transmission device to adjust the position of said camera lens for fine tuning of focus.

9. The modified structure of a projector as claimed in claim 8, wherein said second drive component is a stepper motor, a DC motor, or a servomotor.

10. The modified structure of a projector as claimed in claim 8, wherein said second transmission device is a screw rod set, a belt set, a chain set, or a gear set.

11. The modified structure of a projector as claimed in claim 1, wherein said photo detection component is a CCD or a CMOS.

12. The modified structure of a projector as claimed in claim 1, wherein said camera lens is an electric zoom camera lens.

13. The modified structure of a projector as claimed in claim 12, wherein said electric zoom camera lens can further be remotely controlled by said remote control host machine to automatically adjust the magnification ratio.

14. A modified structure of a projector, comprising:
a projector body with a remote control receiver built therein;
at least a camera lens set installed on said first activating device by using a support arm, said camera lens set comprising a drive component, said drive component driving a transmission device to adjust an electric zoom camera lens for adjustment of the magnification ratio of image and fine tuning of focus so that a photo detection component can pick an image through said electric zoom camera lens; and
a remote control host machine, said remote control host machine being maneuvered to let said remote control receiver receive a signal emitted from said remote control host machine so that said remote control receiver can control said projector for automatic adjustment and setting.

15. The modified structure of a projector as claimed in claim 14, wherein said drive component is a stepper motor, a DC motor, or a servomotor.

16. The modified structure of a projector as claimed in claim 14, wherein said transmission device is a screw rod set, a belt set, a chain set, or a gear set.

17. The modified structure of a projector as claimed in claim 14, wherein said photo detection component is a CCD or a CMOS.

18. The modified structure of a projector as claimed in claim 14, wherein said remote control host machine can further remotely control said camera lens set to let said electric zoom camera lens be capable of automatically performing adjustment of the magnification ratio and fine tuning of focus.

19. The modified structure of a projector as claimed in claim 14, wherein said support arm can be a pull type support arm or a turn type support arm.
